(19) United States
(12) Patent Application Publication
(10) Pub. No.: US 2007/0158431 A1
(43) Pub. Date: Jul. 12, 2007

(54) Wireless image capture apparatus

(75) Inventors: Hsuan Hsien Lee, Hsin-Chu (TW); Chin Hsin Yang, Hsin-Chu (TW)

Correspondence Address: John S. Egbert;Egbert Law Offices, 7th Floor, 412 Main Street, Houston, TX, 77002, US

(73) Assignee: PIXART IMAGING Inc., Hsin-Chu (TW)

(21) Appl. No.: 11/450,682

(22) Filed: Jun. 9, 2006

(30) Foreign Application Priority Data
Dec. 7, 2005 (TW) 094143109

(51) Int. Cl. G06K 7/10

(52) U.S. Cl. 235/472.02

(57) ABSTRACT

A wireless image capture apparatus includes an image sensor, a backend circuit and a radio frequency module. The image sensor converts captured images into digital signals. Subsequently, the backend circuit performs image processing, data compression and format transformation on the digital signals. The output signals of the backend circuit are series-for-mat signals compatible with the radio frequency module. Thus, wireless signals are outputted by the radio frequency module toward the exterior of the apparatus.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a wireless image capture apparatus, and more particularly, to a wireless image capture apparatus equipped with a Bluetooth wireless transmission interface.

### BACKGROUND OF THE INVENTION

Conventional image capture apparatuses or remote monitors generally utilize electrical cables to transmit captured image data. They can securely and speedily send the data to a host. However, the electrical cables are blocked by obstructions or partitions when a building is not previously equipped with pipes for the cables to pass through. In some cases, the walls or floors of the building need to be drilled or modified so that wireways can be well arranged. Furthermore, once the wireways have been already established, they cannot be easily rearranged to adapt to the change of the fixing position for the image capture apparatus. Therefore, conventional image capture apparatuses cannot satisfy the consumer's current varied needs.

Because several wireless transmission technologies are well developed. For instance, IEEE802.11, Wi-Fi, DECT, Wi-MAX and Bluetooth, high-volume image data can be promptly transmitted to a host or a receiver at a high transmission speed. That is, instead of cables, the image capture apparatus utilizes wireless transmission means. Presently, several transceiver devices are equipped with an embedded Bluetooth module, for instance, personal digital assistants (PDA), mobile phones, personal computers and laptop computers. Therefore, the devices with a Bluetooth interface can receive and browse image data wirelessly emitted from an image capture apparatus within a receivable distance.

As shown in FIG. 1, U.S. Pat. No. 6,956,599 proposed a remote monitor system 10 comprising a mobile video phone 11 and an independent camera 14 which communicate with each other. However, either the mobile video phone 11 or the independent camera 14 requires one of connectors 12 and 15 and one of dynamic assistants 13 and 16 to communicate with each other in a wireless manner. The dynamic assistants 13 and 16 respectively include one of Bluetooth modules 131 and 161. A remotely monitoring user can utilize another mobile video phone 18 or a personal computer 19 to control the camera 14 to capture images and transmit image data (referring to Column 2, lines 54-62 in the specification). The wireless transmission path goes through a wireless network 17, the mobile video phone 11, the connector 12, the Bluetooth module 131 of the dynamic assistant 13, the Bluetooth module 161 of the dynamic assistant 16, and the connector 15. Afterward, the camera 14 simply receives instructions from the remote control side. Therefore, the mobile video phone 11 in the system 10 acts as a repeater or a bridge, and the real image monitor is the mobile video phone 18 rather than the mobile video phone 11. Apparently, the system 10 can monitor images in a certain location through the Internet, but the necessary repeaters and relay devices are quite complicated. Consequently, most families or individuals will face difficulty when installing and maintaining such a system.

As a result, there is need of an image capture apparatus compatible with the conventional mobile transceiver to simplify the installation of the monitor system. Furthermore, the fixing position of the image capture apparatus can be effortlessly changed.

### BRIEF SUMMARY OF THE INVENTION

An objective of the present invention is to provide a wireless image capture apparatus integrated with a Bluetooth module so that a receiver device equipped with a Bluetooth communication function can directly display a remote static or dynamic image.

Another objective of the present invention is to provide an image capture apparatus under remote control. The power switch of the image capture apparatus is under the control of the setting instructions from a radio frequency module.

To achieve the objective, the present invention discloses a wireless image capture apparatus comprising an image sensor, a backend circuit and a radio frequency module. The image sensor converts the captured image into digital signals. Subsequently, the backend circuit performs image processing, data compression and format transformation on the digital signals. The output signals of the backend circuit are series-format signals compatible with the radio frequency module. Thus, wireless signals are outputted by the radio frequency module toward the apparatus' exterior.

The radio frequency module is a Bluetooth module, and the backend circuit includes a universal asynchronous receiver transmitter (UART) interface which generates series-format signals compliant with Bluetooth protocols.

The image capture apparatus is compatible with current mobile transceivers capable of displaying images. Therefore, it is suitable for individuals and families wishing to install an on-line monitor system. Furthermore, they can control the power switch of the image capture apparatus through the bidirectional communication of the radio frequency module at a monitor site.

### BRIEF DESCRIPTION OF THE SEVERAL VIEWS OF THE DRAWINGS

The invention will be described according to the appended drawings.

FIG. 1 is a schematic view of a diagram of a known remote monitor system.

FIG. 2 is a schematic view of an application diagram of a wireless image capture apparatus in accordance with the present invention.

FIG. 3 is a schematic view of a function block diagram of a wireless image capture apparatus in accordance with the present invention.

FIG. 4 is another schematic view of a function block diagram of a wireless image capture apparatus in accordance with the present invention.

### DETAILED DESCRIPTION OF THE INVENTION

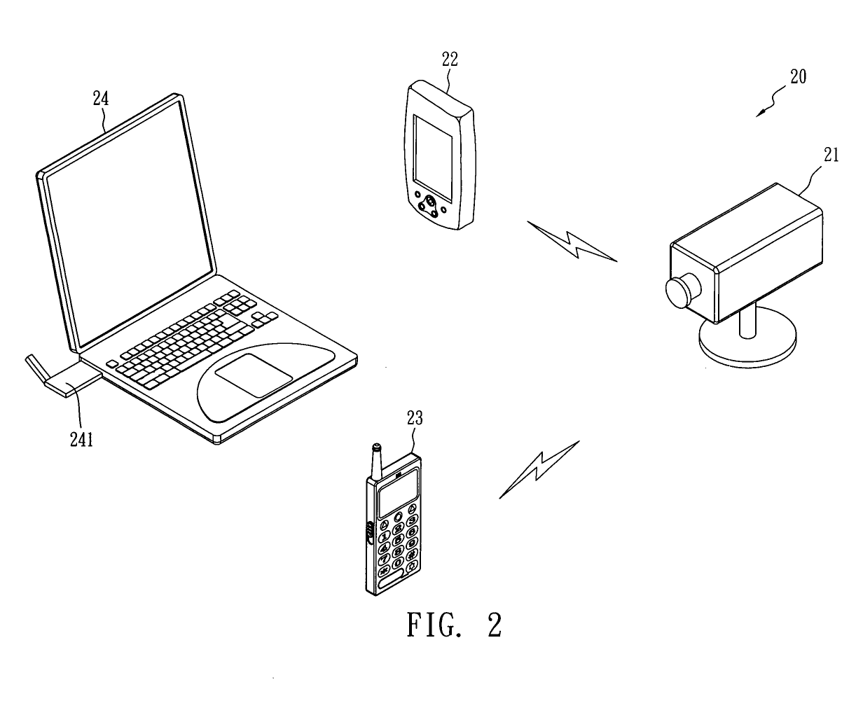

FIG. 2 is a schematic application diagram of a wireless image capture apparatus in accordance with the present invention. In the applied system 20, an image capture apparatus 21 is placed at a predetermined location, and its orientation is adjusted to capture preferred images. For example, the image capture apparatus 21 is placed in a bedroom to monitor the activity or sleep of an infant. The image capture apparatus 21 converts the captured images into radio frequency signals and emits the signals outwards. The radio frequency signals are wireless signals detected by a mobile phone 23 and a PDA 22 as Bluetooth signals. Therefore, the screen of the mobile phone 23 or the PDA 22 is utilized to monitor the current captured images sent from the remote image capture apparatus 21. Furthermore, a laptop computer 24 with a wireless transmission interface card 241 can also be utilized to receive the wireless signals and show the current captured images on its screen.

Like the mobile phone 23 and the PDA 22, increasing numbers of such mobile transceiver devices have embedded Bluetooth modules; hence, the image capture apparatus 21 integrated with a Bluetooth module is preferable for consumer requirements. The Bluetooth protocols utilize an ISM (Industrial, Scientific, Medical) band with a central frequency of 2.4 GHz, which is free to use. The corresponding frequency band is divided into 79 different channels, and the frequency band of each channel is 1 MHz. To avoid interference between wireless apparatuses employing the ISM band, a Frequency-Hopping Spread Spectrum (FHSS) technique is utilized to perform the difficult frequency swap rate of 1,600 times a second. In addition, an encryption technique is utilized so that the data exchange security is highly safe. Accordingly, the effective baud rate of the Bluetooth wireless apparatus is from 432 to 721 Kbps, and the effective transmitting distance is from 10 to 100 meters.

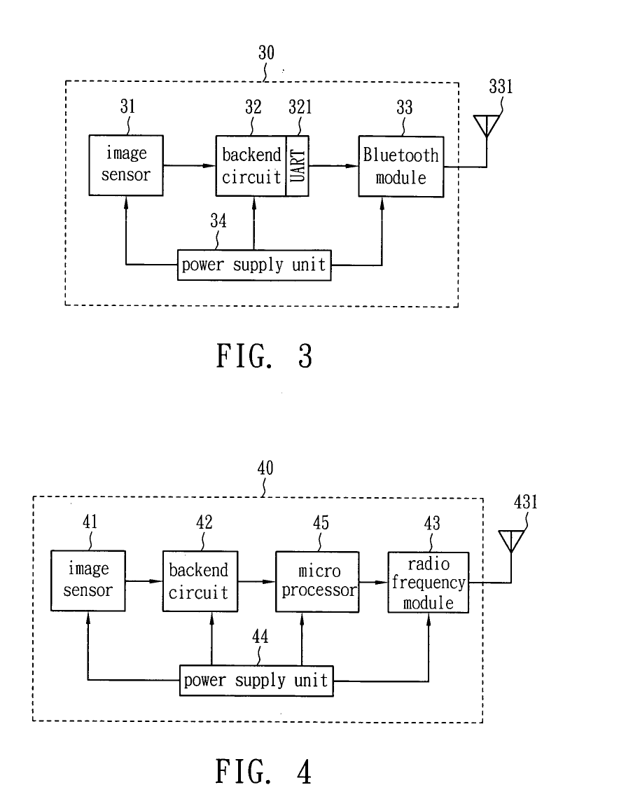

FIG. 3 is a function block diagram of a wireless image capture apparatus in accordance with a preferred embodiment of the present invention. The image capture apparatus 30 comprises an image sensor 31, a backend circuit 32 and a radio frequency module 33, and further comprises a power supply unit 34 powering each of the aforesaid elements. The image sensor 31 converts the optical image signals into digital image signals. An active image sensor fabricated by complementary metal-oxide semiconductor (CMOS) processes the image, or a charge coupled device (CCD) can be employed as the image sensor 31.

In order to prevent the transmission speed from being slowed down by digital image signals with high data volumes, the backend circuit 32 can compress the digital image signals. Furthermore, when the captured images need to be modified, the backend circuit 32 changes the brightness and hue of the images, or executes image processes to have special modification effects on the images. The backend circuit 32 includes a UART interface 321 outputting series-format signals for the Bluetooth module 33 to directly convert them into radio frequency signals. In general, there is no need for a repeater or a bridge. The backend circuit 32 can be a multimedia chip apart from the chip of the image sensor 31. Moreover, the backend circuit 32 and the image sensor 31 can be integrated into a single chip. The mobile phone 23 not only receives the radio frequency signals from the Bluetooth module 33, but also emits Bluetooth signals towards the antenna 331 of the duplex communication Bluetooth module 33. The power switch and orientation of the image capture apparatus 30 are controlled by the user via Bluetooth signals. The power supply unit 34 is a battery set or a transformer converting external power to the voltage specifications required by internal circuits.

As shown in FIG. 4, in addition to the Bluetooth protocols, a radio frequency module 43 can utilize other wireless transmission technologies such as IEEE802.11, Wi-Fi, DECT and Wi-MAX to receive and transmit wireless signals for an image capture apparatus 40. The image capture apparatus 40 comprises an image sensor 41, a backend circuit 42, a microprocessor 45 and a radio frequency module 43, and further comprises a power supply unit 44 powering each of the aforesaid elements. The image sensor 41 converts the optical image signals into digital image signals. The backend circuit 42 can process and compress the digital image signals. Because the output signals of the backend circuit 42 are not consistent with the signal format that the Bluetooth module 43 requires, the microprocessor 45 can convert the output signals into Bluetooth-format signals. Finally, the radio frequency module 43 transmits radio frequency signals through an antenna 431.

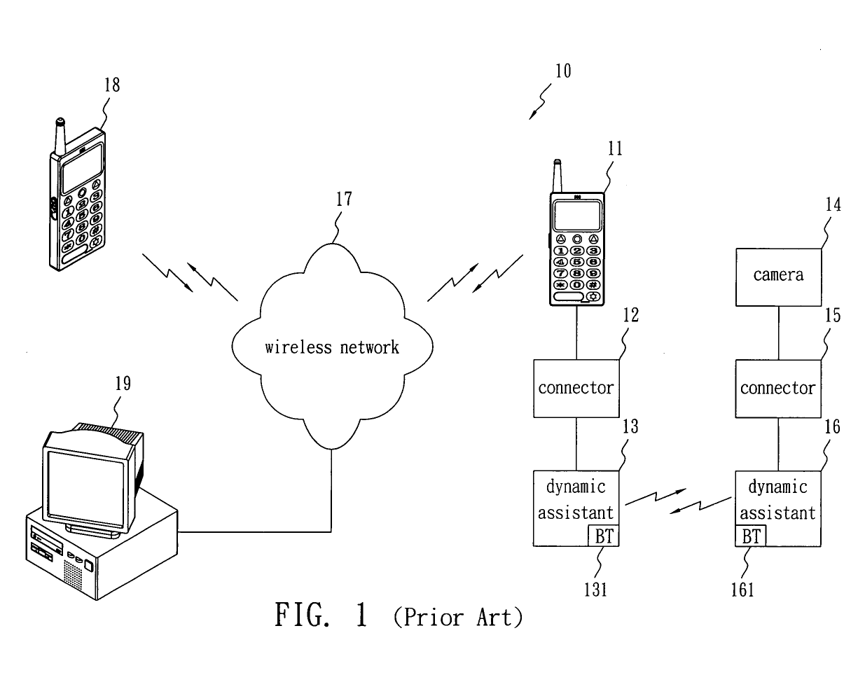

In comparison with the prior art in FIG. 1, the image capture apparatus of the present invention does not need any repeater or bridge. Therefore, it is suitable for unrestricted application to monitor systems, and reduces the cost of the system installation. Furthermore, the prior art does not clearly disclose the function blocks of the camera 14; hence, the present invention is superior to the prior art especially on novelty and result.

The above-described embodiments of the present invention are intended to be illustrative only. Numerous alternative embodiments may be devised by persons skilled in the art without departing from the scope of the following claims.

We claim:

1. A wireless image capture apparatus, comprising:
an image sensor receiving optical signals of an image and converting the optical signals into digital signals;
a backend circuit performing image processing and data compression on the digital signals and converting the digital signals to be of UART format; and
a Bluetooth module converting the digital signals of UART format into wireless Bluetooth signals and emitting the wireless Bluetooth signals outward.

2. The wireless image capture apparatus of claim 1, further comprising:
a power supply unit providing power for said image sensor, said backend circuit and said Bluetooth module.

3. The wireless image capture apparatus of claim 2, wherein said power supply unit is comprised of a battery set.

4. The wireless image capture apparatus of claim 1, wherein the image sensor is a CMOS sensor or a CCD sensor.

5. The wireless image capture apparatus of claim 1, wherein said Bluetooth module is a duplex module, receiving external wireless Bluetooth signals.

6. The wireless image capture apparatus of claim 1, wherein said backend circuit is comprised of a UART interference.

7. The wireless image capture apparatus of claim 1, wherein the backend circuit is a multimedia chip.

8. The wireless image capture apparatus of claim 7, wherein the backend circuit and the image sensor are integrated into a single chip.

9. A wireless image capture apparatus, comprising:
an image sensor receiving optical signals of an image and converting the optical signals into digital signals;
a backend circuit performing image processing and data compression on the digital signals;
a microprocessor converting signal formats of the digital signals outputted from the backend circuit; and
a radio frequency module receiving output signals of the microprocessor, converting the output signals into radio frequency signals, and emitting the radio frequency signals outward.

10. The wireless image capture apparatus of claim 9, further comprising:
a power supply unit providing power for said image sensor, said backend circuit, said microprocessor and said radio frequency module.

11. The wireless image capture apparatus of claim 10, wherein said power supply unit is comprised of a battery set.

12. The wireless image capture apparatus of claim 9, wherein the radio frequency module is a radio frequency processing circuit in compliance with one of IEEE802.11, Wi-Fi, DECT and Wi-MAX.

13. The wireless image capture apparatus of claim 9, wherein the image sensor is a CMOS sensor or a CCD sensor.

14. The wireless image capture apparatus of claim 9, wherein the backend circuit is a multimedia chip.

15. The wireless image capture apparatus of claim 9, wherein the backend circuit and the image sensor are integrated into a single chip.
